(19) United States
(12) Patent Application Publication
(10) Pub. No.: US 2026/0266279 A1
(43) Pub. Date: Sep. 10, 2026

(54) HYDROGEN STORE HAVING A LIQUID PISTON

(71) Applicant: MAXIMATOR GMBH, Nordhausen (DE)

(72) Inventors: Michael ADLER, Margarethen am Moos (AT); Christoph NAGL, Wien (AT); Robert ADLER, Wien (AT); Markus RASCH, Wien (AT); Markus STEPHAN, Wien (AT)

(21) Appl. No.: 19/166,423

(22) PCT Filed: Mar. 15, 2024
(86) PCT No.: PCT/EP2024/056942

§ 371 Date: Sep. 17, 2025

(30) Foreign Application Priority Data
Mar. 17, 2023 (EP) 23162586.4

(51) Int. Cl. F04B 39/00; F04B 15/00; F04B 23/02; F04B 53/14

(52) U.S. Cl. CPC F04B 39/0011; F04B 15/00; F04B 23/02; F04B 53/141

(57) ABSTRACT

The invention relates to a hydrogen compressor and/or displacer, in particular a hydrogen reservoir for storing hydrogen, comprising: a hydrogen volume filled with hydrogen, and a working fluid volume filled with a working fluid, wherein the working fluid is designed as a piston for changing the hydrogen volume, characterized in that the working fluid comprises a polyalphaolefin. The invention further relates to a method for displacing and/or compressing hydrogen, comprising the steps of: (a) providing the hydrogen compressor and/or displacer according to the invention, and (b) replenishing working fluid into the hydrogen compressor and/or displacer, such that the working fluid volume of the hydrogen compressor and/or displacer is increased and the hydrogen volume of the hydrogen compressor and/or displacer is reduced.

### CROSS REFERENCE TO RELATED APPLICATIONS

The present application is a U.S. National Phase of International Application No. PCT/EP2024/056942 entitled “HYDROGEN STORE HAVING A LIQUID PISTON”, and filed on Mar. 15, 2024. International Application No. PCT/EP2024/056942 claims priority to European Patent Application No. 23162586.4 filed on Mar. 17, 2023. The entire contents of each of the above-listed applications are hereby incorporated by reference for all purposes.

### TECHNICAL FIELD

The invention relates to a hydrogen compressor and/or displacer, preferably a hydrogen reservoir for storing hydrogen or a housing-piston unit, comprising:
a hydrogen volume filled with hydrogen, and
a working fluid volume filled with a working fluid, wherein the working fluid is designed as a liquid piston for changing, namely for enlarging and/or reducing, the hydrogen volume.

### BACKGROUND AND SUMMARY

The invention further relates to a method for displacing and/or compressing hydrogen.

The invention further relates to a housing-piston assembly comprising:
a housing, preferably a cylinder, wherein the housing includes a working volume for receiving hydrogen,
a solid piston movable relative to the housing for changing the working volume, and
a seal for sealing the movement of the solid piston relative to the housing, wherein a sealing fluid is provided as the seal.

The invention further relates to a rotor comprising:
an axis of rotation,
a rotary drive, and
such a housing-piston assembly.

Finally, the invention relates to a method for sealing the movement of a solid piston relative to a housing.

In a first embodiment of the invention, a hydrogen compressor or hydrogen displacer and a corresponding method are provided in which hydrogen is compressed or displaced by means of a working fluid in direct contact with the hydrogen, referred to here as working fluid. In a first variant according to the invention, the hydrogen compressor or displacer can be designed as a hydrogen reservoir, from which hydrogen can be transferred, for example, into a hydrogen tank of a vehicle. In the hydrogen reservoir, the working fluid acts as a liquid piston in order to compress or displace the hydrogen in direct contact with the hydrogen. In a second variant according to the invention, the hydrogen compressor or displacer can be designed as a housing-piston unit with an, in particular cylindrical, housing, in which the working fluid, also in the form of a liquid piston in direct contact with the hydrogen, is moved to compress or displace the hydrogen, in particular moved back and forth in an axial direction of the housing.

US 2007/258828 A1 describes a hydrogen reservoir in which a working fluid is used as a liquid piston. In this prior art, the working fluid is preferably an ionic fluid, a hydraulic oil with a high boiling point, or a fluid with a very low vapor pressure; examples include vacuum pump oils, molten salts and metals with a low melting point, as well as fluids with a gas solubility of less than 10-4 mol/l bar (US 2007/258828 A1, [0017]).

US 2007/258828 A1 focuses on ionic fluids-these are consistently described as advantageous, e.g. in para. [0018], [0019], [0021]-[0023], [0047] and [0050]. The use of vacuum pump oil, on the other hand, is mentioned only once in US 2007/258828 A1, namely in para. [0017], without any particular associated advantages being highlighted. Therefore, if a person skilled in the art were to select a working fluid based on US 2007/258828 A1, this would be an ionic fluid.

US 2007/258828 A1 does not mention which ionic fluids could specifically be used. From US 2010/154924 A1, the person skilled in the art is aware that not all ionic fluids are suitable as liquid pistons (US 2010/154924 A1, [0017]). In the search for suitable ionic fluids, the skilled person would refer to Kermani et al., Int. Journal of Hydrogen Energy, 45(33), 2020-in which a study is carried out to determine ionic fluids suitable as liquid pistons. Consequently, based on the cited documents, the skilled person would select an ionic fluid identified as suitable in Kermani et al., Int. Journal of Hydrogen Energy, 45(33), 2020 as a working fluid for a reservoir.

However, the ionic fluid is electrically conductive, which causes the problem of the electrochemically effective voltage series when, as in the applications according to the invention, different metals can meet. This could lead to an unintentional coating flow between the metals via the ionic fluid.

U.S. Pat. No. 6,066,604 A discloses a vacuum pump oil whose base oil can be a synthetic oil and a mineral oil. A polyalphaolefin with 4-14 carbon atoms per molecule may be used as a synthetic oil. The mineral oil used may be, for example, paraffinic mineral oils (in particular isoparaffins) or naphthenic mineral oils (U.S. Pat. No. 6,066,604 A, column 1, line 59 to column 2, line 41).

EP 3 508 559 A1 also relates to vacuum pump oils, the use of a synthetic oil (e.g. polyalphaolefin) in a vacuum pump oil only being mentioned in combination with a mineral oil. According to EP 3 508 559 A1, care must be taken to ensure that the effects are not adversely affected by the presence of the synthetic oil. Accordingly, EP 3 508 559 A1 prefers a synthetic oil to be contained in the vacuum pump oil only in a small amount or not at all (EP 3 508 559 A1, [0134]-[0136]).

However, it would not be obvious to the person skilled in the art to use a vacuum pump oil with polyalphaolefin according to U.S. Pat. No. 6,066,604 A or EP 3 508 559 A1 as the working fluid of US 2007/258828 A1.

Although U.S. Pat. No. 6,066,604 A mentions the use of a polyalphaolefin as a vacuum pump oil, U.S. Pat. No. 6,066,604 A focuses on achieving good vacuum quality and on simplified starting of pumps in low-temperature applications (U.S. Pat. No. 6,066,604 A, column 1, lines 4-7). Due to this different field of application, a person skilled in the art would have no reason to consider U.S. Pat. No. 6,066,604 A for applications in hydrogen reservoir.

The vacuum pump oils are subject to completely different loads than the working fluid of the hydrogen compressor or displacer according to the invention. The vacuum pump uses a rotor that is sealed by a vacuum pump oil. Such a rotary pump requires a high throughput at low working pressure to achieve the vacuum. With the hydrogen compressor or displacer, it is exactly the opposite. Typically, the hydraulically driven hydrogen compressor (in contrast to a piston compressor with crank drive) uses an axial piston or radial piston pump, which places high demands on the oil films exposed to considerable surface pressures and their load-bearing capacity. In contrast, vacuum pumps do not have high surface pressures, so that much lower requirements are placed on wear protection.

On the other hand, in vacuum pumps, the vapor pressure is decisive at moderate ambient and thus also operating temperatures, in particular between −20 °C and +60 °C, in particular between 0 °C and 30 °C, since boiling at low pressures is to be avoided. In the hydrogen compressor, on the other hand, the working fluid should evaporate only slightly at high temperatures or pressures. This is due in particular to the fact that hydrogen gas for technical applications often has high purity requirements and is usually compressed to high pressures due to the low density.

In view of the different requirements for a vacuum pump oil (sealing at high throughput, low pressure and low temperatures) compared to the hydrogen compressor according to the invention (sealing at relatively low volumetric throughput, high pressure with considerable surface pressures and high temperatures), the person skilled in the art would not use the known vacuum pump oils for the use according to the invention in the hydrogen compressor.

In a second embodiment of the invention, a cylinder-piston assembly and a corresponding method are provided in which the movement of a solid piston in a housing of a housing-piston assembly is sealed by a sealing fluid.

U.S. Pat. No. 4,750,409 A discloses a device for compressing gas. For this purpose, a piston, which has a sealing groove, is moved in a bore. Lubricant is located on an upper side of the piston and enters the sealing groove via grooves running from the upper side of the piston to the sealing groove. The lubricant ensures smooth movement of the piston and lubricates the seal located in the sealing groove, reducing its wear. A hydraulic oil is used as lubricant.

US 2016/145523 A discloses a compressor oil and a method for producing it. The compressor oil comprises a hydrocarbon oil having a sulfur content of 0.1% by weight or less and an aromatics content of 1% by weight or less, wherein the proportion of hydrocarbons having 10 or less carbon atoms is less than 100 ppm with respect to mass. US 2016/145523 A cites an experiment in which a polyalphaolefin was mixed with the antifoam dimethylpolysiloxane and prepared according to the disclosed method. The mixture is then used for the compression of hydrogen. However, the decomposition temperature of the dimethylpolysiloxane is already reached at about 200 °C, so that only limited pressure conditions would be achievable. In addition, the addition of antifoam additives has a negative effect on the surface tension and thus on the lubricating properties in axial piston or radial piston pumps. This fluid would therefore be unsuitable for the application according to the invention.

As described at the outset in WO 2006/034748 A1, piston compressors are regularly used when compressing gaseous media in order to keep the medium to be compressed separate from the medium driving the piston, for example hydraulic oil. When compressing hydrogen, accurate cylinders with pistons and effective dynamic sealing systems are required. These lead to high production and maintenance costs. Therefore, even more cost-intensive compression technologies, such as diaphragm compressors and lubrication-free piston compressors, are often used for such applications. Against this background, WO 2006/034748 A1 discloses a method and a device for compressing hydrogen, in which the compression takes place with a working fluid in which the gas does not dissolve and/or which can be separated from the gas without leaving a residue. Thus, pistons made of a solid material are replaced by a non-compressible liquid column. The working fluid may be an ionic liquid, a high-boiling hydraulic oil, a liquid having a very low vapor pressure (e.g., vacuum pump oils, molten salts, and low-melting point metals), or a liquid having a gas solubility of less than 10-4 mol/l bar.

WO 2006/120145 A1 also relates to a working fluid for compressing hydrogen, which transmits the force required for compression directly to the gas and has a vapor pressure of less than 10-3 mbar. The working fluid may be a molecular fluid, e.g., a mineral oil, a silicone oil, or a synthetic oil.

DE 10 2011 101 504 A1 discloses a further method for compressing hydrogen with a working fluid. An ionic liquid, a perfluorinated polyether or a thermal oil may be used as the working fluid.

DE 198 48 234 A1 relates to a method and a compressor for compressing a gas. In this case, the gas and a working fluid are located in a container, and the gas is compressed by raising the filling level of the working fluid. The working fluid used may be a liquid which has a low vapor pressure and/or does not enter into any connection with the gas, for example silicone oils, water or hydrocarbons.

Finally, DE 10 2015 016327 A1 describes a filling station for filling storage containers in mobile vehicles with hydrogen. The hydrogen is stored in one or more constant pressure accumulators, with which the gas is made available at a certain, constant pressure. For this purpose, the constant pressure accumulator has a cylinder, which is divided into two regions by a movable separating piston. The first area absorbs the hydrogen. The second region receives a fluid, for example, a hydraulic fluid. During the storage phase, the pressure of the hydrogen in the first region is kept constant by displacing the separating piston, wherein the first region is enlarged and the second region is reduced. During the withdrawal phase, the volume of the first area is reduced by pumping more liquid into the second area and increasing the volume of the second area so that the pressure in the first area is kept constant.

As described in EP 3 514 380 A1, the sealing of a classic compressor piston from a solid body is very complicated and complex. This applies in particular to the compression of hydrogen, which places the highest demands on the seals. Thus, frequent seal replacement is required. EP 3 514 380 A1 proposes a compressor in which the seal replacement is automated. If the high-pressure seal can no longer ensure the sealing of the high-pressure piston due to wear or damage, a replacement device is activated with which the high-pressure seal is replaced by a replacement high-pressure seal. If all (replacement) high-pressure seals are worn, the magazine as a whole can be exchanged for a corresponding magazine with unused replacement high-pressure seals or new replacement high-pressure seals can be inserted into the magazine. Thus, the replacement of the seal can be significantly facilitated with this seal changer. In contrast, however, it would be desirable to further improve the sealing of a compressor piston when compressing hydrogen, so that a replacement of the seal is not necessary in the first place or at least less rarely necessary.

WO 2013/079692 A1 discloses a different type of ball valve with an external sealing assembly in which a sealing fluid is used. The use of a polyalkylene glycol as a sealing fluid is described.

The working fluids mentioned in the prior art have proven to be unsuitable or disadvantageous for the applications described above. Some of the working fluids known in the prior art are highly viscous, for example mineral oils, hydraulic oils, synthetic oils and perfluorinated polyethers. A high viscosity is associated with a high tendency to foam, which can increase the cavitation tendency of the working fluid and consequently the wear of system parts. Carryover of the working fluid from the intended process space can also occur. This problem is critical, for example, when refueling a vehicle with hydrogen when transferring the hydrogen from the hydrogen reservoir to the hydrogen tank of the vehicle. In any case, entrainment of the working fluid into the hydrogen tank of the vehicle must be avoided. Other working fluids known in the prior art, such as thermal oils, water and hydrocarbons, have a high gas solubility or a high vapor pressure and therefore tend to be brought into the gas phase. The working fluids known in the prior art can thus be disadvantageous for stable process control and the service life of the plants in the applications described at the outset.

Thus, the object of the present invention is to alleviate or eliminate at least individual disadvantages of the prior art. In particular, there is a need for working fluids and sealing fluids with which a high process stability is ensured in the applications described at the outset and the wear of the system parts is as low as possible.

This object is achieved by a hydrogen compressor and/or displacer, a method for compressing and/or displacing hydrogen, a housing-piston assembly, a rotor, and a method for sealing the movement of a solid piston relative to a housing as described herein.

In the first embodiment according to the invention as a hydrogen compressor and/or displacer, the work required for compressing and/or displacing the hydrogen can be performed with the aid of the working fluid comprising the polyalphaolefin. In the second embodiment according to the invention as a housing-piston assembly, the movement of the solid piston relative to the housing can be sealed with the aid of the sealing fluid comprising the polyalphaolefin. In both versions, the use of a polyalphaolefin (PAO) is surprising, as special advantages are achieved without having to accept the disadvantages typical of PAO.

Practical tests have shown that a particular advantage of the PAO for the applications according to the invention is its thin liquid, i.e. its low viscosity. This can, for example, avoid the problem that gases dissolved in the fluid as a result of pressure changes lead to foaming of the fluid during re-expansion. Such foaming could increase the cavitation tendency, for example in a pump that replenishes the working fluid, preferably an axial or radial piston pump, which would increase the wear of the pump. When refueling a vehicle with hydrogen, foaming of the working fluid could further cause fluid carryovers into the hydrogen tank, which, however, should be avoided. In the prior art, highly viscous working fluids, for example ionic liquids, have been proposed which have a high tendency to foam, which should be compensated by a very low gas solubility. In fact, however, the required low gas solubility was not achieved in practice. Other working fluids such as mineral oils, synthetic oils and hydraulic oils are so viscous that foam formation would make use in the applications according to the invention very disadvantageous or impossible. On the other hand, because of their tendency to carry over, thermal oils are unsuitable, in particular, for use in plants that provide hydrogen for fuel cell-powered vehicles. The use of the PAO according to the invention is based on the finding that with the low tendency of the PAO to foam, foam formation can be reliably avoided without requiring an extremely low gas solubility. In the applications according to the invention, the low foaming of the PAO can be used optimally, even if the gas solubility of the PAO is quite low in absolute terms, but higher than in the case of the ionic liquids.

A “polyalphaolefin” is understood to mean a poly-1-olefin which has been prepared by polymerization of alphaolefins. The term “polyalphaolefin” includes polyalphaolefin homopolymers, polymers composed of two or more different monomer units (e.g., polyalphaolefin copolymers, polyalphaolefin terpolymers), and mixtures thereof.

The working fluid preferably comprises the polyalphaolefin in an amount of 80% by weight or more, more preferably 90% by weight or more, even more preferably 95% by weight or more, particularly preferably 99% by weight or more, based on the total weight of the working fluid. As a result, the positive properties of the polyalphaolefin with regard to low gas solubility and low tendency to foam can be used effectively.

Depending on the design, the working fluid may have exactly one polyalphaolefin. In a preferred embodiment, the working fluid comprises a mixture of two or more polyalphaolefins. The physical properties of the working fluid (e.g. viscosity, boiling point) can then be adapted to the respective conditions.

The polyalphaolefin may have an unbranched or a branched chain structure (n-alkane or iso-alkane). A mixture of an unbranched polyalphaolefin and an isomer of the same polyalphaolefin or a polyalphaolefin having a different number of carbon atoms may also be used. This allows the boiling point of the working fluid to be adjusted. In particular, the branched molecules have a considerable influence on the viscosity of the working fluid.

In a preferred embodiment, at least 90% by weight of the polyalphaolefin has 19 or fewer carbon atoms per molecule, preferably 14 to 18 carbon atoms per molecule, more preferably 16 to 18 carbon atoms per molecule, based on the total weight of the polyalphaolefin. Preferably, at least 95% by weight of the polyalphaolefin has such a number of carbon atoms, more preferably at least 99% by weight, based on the total weight of the polyalphaolefin. Polyalphaolefins with such a number of carbon atoms have a particularly low gas solubility and a particularly low tendency to foam, so that they are well suited as a working fluid. If the working fluid has two or more polyalphaolefins, preferably all polyalphaolefins have such a number of carbon atoms.

Preferably, a maximum of 10% by weight of the polyalphaolefin has 20 or more carbon atoms, in particular 20 to 30 carbon atoms, based on the total weight of the polyalphaolefin. Preferably, a maximum of 5% by weight of the polyalphaolefin has such a number of carbon atoms, more preferably a maximum of 3% by weight, based on the total weight of the polyalphaolefin. As a result, the viscosity can be kept low, which is associated with a low tendency to foam.

The working fluid preferably has a content of an aromatic hydrocarbon of at most 1% by weight, preferably at most 0.5% by weight, based on the total weight of the working fluid. This also allows the viscosity and consequently the tendency to foam to be kept low.

A content of a sulfur compound in the working fluid is preferably at most 10,000 ppm, more preferably at most 1,000 ppm, based on the total weight of the working fluid. This makes it possible, in particular, to avoid an effect as a cellular poison in vehicles with fuel cell drive.

The working fluid preferably has a decomposition temperature (i.e. a temperature at which the working fluid is irreversibly decomposed) of at least 250 °C, preferably of at least 280 °C, under ambient conditions (temperature 293.15 Kelvin; normal pressure 101325 Pascal). However, it is harmless if the working fluid boils reversibly below this decay temperature.

The operating temperature of the working fluid is preferably at least from 0 °C to 210 °C or from ÷50 °C to +250 °C or up to 280 °C, in each case under ambient conditions.

In a further preferred embodiment, the working fluid is free of an anti-foaming agent, in particular free of dimethylpolysiloxane. The addition of an anti-foaming agent or additive would have a negative effect on the surface tension and thus on the lubricating properties, in particular in an axial or radial piston pump.

The composition of the working fluid can be determined by means of two-dimensional gas chromatography with mass spectrometry coupling (2D-GC-MS) (Orbitrap Exploris GC 60K MSMs, Thermo Fisher Scientific). For this purpose, a sample comprising 4% by weight of the working fluid in dichloromethane can be prepared. The parameters may be set as follows:

For Gas Chromatography (GC): Cold feed injector (PVT injector) from 40 °C to 300 °C at 2.5 °C/sec; heat oven from 40 °C to 150 °C at 5 °C/min and then to 300 °C at 3 °C/min; column flow of 0.5 ml/min, transfer at 250 °C, detector flow of 20 ml/min.

For the Flame Ionization Detector (FID): 200 Hz, 300 °C, 350 ml/min air, 10 ml/min feeding, 35 ml/min hydrogen.

For Mass Spectrometry (MS): 200 °C, solvent delay 7 min, m/z from 30 to 650, 15 k, cold trap offset 1.5 V.

This measurement can be used to determine the content of volatile polyalphaolefins with a certain number of carbon atoms, as well as the content of volatile aromatic hydrocarbons and the content of volatile sulfur compounds. For the determination of quantitative contents, a corresponding calibration of the analytes is necessary.

The instrument is structured as follows:
1. Dimensions column: BPX 5, 20 m×0.18 mm×0.18 μm

Flow modulator with loop 23 cm×0.53 mm and bleedline 5 m×0.1 mm; modulation 3 s, with flushing time 100 ms
2. Dimensions column: BPX 50, 5 m×0.25 mm×0.1 μm

Detectors: FID, TCD, mass spectrometer (Exploris: electron impact ionization and quadrupole+orbitrap), split ratio MS 5:1 TCD/FID

At 50 °C and a pressure of 50 bar, the hydrogen preferably has a solubility in the working fluid selected from a range of 0.02 to 0.15 liters (L) of hydrogen per liter of working fluid, preferably substantially 0.07 L of hydrogen per L of working fluid. There is then a slight tendency of the working fluid to be brought into the gas phase, or conversely a slight tendency of the hydrogen to be dissolved in the working fluid. Thus, good process stability can be achieved.

It is preferred if the working fluid at 70 °C has a viscosity selected from a range of 1 to 10 centistokes (cSt), preferably 1 to 5 cSt, in particular 2.5 to 4 cSt. Due to this low viscosity, it can be at least largely avoided that hydrogen dissolved in the working fluid due to pressure changes leads to foaming of the working fluid during re-expansion, which can subsequently increase the cavitation tendency of the working fluid and lead to wear of the system parts. The low viscosity of the working fluid also prevents the working fluid from being entrained and carried away with the gas. Due to this low viscosity, the working fluid according to the invention may indeed have poorer tribological properties, in particular lower friction, compared to working fluids customary in the prior art, e.g. mineral oils or hydraulic oils. However, this can be well compensated for, for example, by hydrostatic lubrication and/or a suitable material pairing.

The gas solubility can be measured in a known manner using a “pressure decay method” under isothermal conditions.

The working fluid preferably has exactly one boiling point (when using exactly one PAO) or an upper end of a boiling range (when using two or more PAOs) of at most 250 °C. The working fluid preferably has a boiling point or a boiling range selected from an interval of 90 °C to 200 °C. Due to the low boiling point or boiling range, the working fluid can evaporate due to an increase in temperature during operation. If the working fluid, as preferred, is used in a closed circuit, this is not disadvantageous, but the working fluid can subsequently condense again, and evaporation of the working fluid by pressurization can be avoided.

In the hydrogen reservoir, the working fluid volume may be below the hydrogen volume. This is due to the fact that the working fluid has a higher density than the hydrogen. The working fluid and the hydrogen are in direct contact with each other in the hydrogen reservoir, wherein the hydrogen volume and the working fluid volume adjoin each other at a layer. This layer can lie in a horizontal plane due to gravity.

In the hydrogen reservoir, a first opening may be arranged on a first side of the hydrogen reservoir to replenish working fluid into the hydrogen reservoir. A second opening may be provided on a second side of the hydrogen reservoir to discharge hydrogen from the hydrogen reservoir. The second side may be arranged opposite the first side. The volume of the hydrogen reservoir can then be well utilized, and the working fluid volume can be displaced as completely as possible by the working fluid volume during the removal of hydrogen.

Preferably, the initial pressure of the hydrogen in the hydrogen reservoir, i.e. the nominal pressure of the hydrogen before the withdrawal of hydrogen and without replenishment of the working fluid, so that the hydrogen volume and the working fluid volume each remain constant, is more than 500 bar, preferably more than 600 bar, in particular more than 700 bar, for example substantially 800 bar, and/or a maximum of 875 bar. As a result of this pressurization, evaporation of the working fluid can be reduced or completely avoided. Thus, there can be no or only a small loss of boiling, albeit limited in time in a closed hydraulic system.

The invention further relates to a system for compressing and/or displacing hydrogen, comprising:
a hydrogen compressor and/or displacer in any of the above embodiments,
a pump, in particular an axial piston or radial piston pump, for replenishing the working fluid into the working fluid volume.

The method according to the invention for displacing and/or compressing hydrogen comprises at least the following steps:
(a) providing the hydrogen compressor or displacer in any of the above-described embodiments, and
(b) replenishing working fluid into the hydrogen compressor or displacer such that the working fluid volume of the hydrogen compressor or displacer is increased and the hydrogen volume of the hydrogen compressor or displacer is reduced.

In step (b), the working fluid serves as a liquid piston, with which the force required for the compression and/or displacement of the hydrogen is transmitted to the hydrogen. By replenishing working fluid, i.e. increasing the volume of working fluid inside the hydrogen compressor or displacer, the hydrogen volume can be reduced, wherein the hydrogen is at least partially compressed and/or at least partially discharged from the gas reservoir. The extent to which the hydrogen volume is reduced in each case may depend, among other things, on the pressure with which working fluid is fed into the gas reservoir and on the density of the hydrogen in the hydrogen reservoir provided.

The invention further relates to a method for filling a hydrogen tank, in particular of a vehicle, with hydrogen, comprising the steps of:
(a) providing a hydrogen reservoir in one of the above-described embodiments with a hydrogen-filled hydrogen volume,
(b) providing a working fluid reservoir with a working fluid,
(c) connecting the hydrogen reservoir to the hydrogen tank so that hydrogen is transferred from the hydrogen reservoir to the hydrogen tank in an outflow phase, and
(d) connecting the working fluid reservoir to the hydrogen reservoir so that working fluid is pumped from the working fluid reservoir into the hydrogen reservoir in a post-compression phase, preferably overlapping with the outflow phase, thereby reducing the hydrogen-filled hydrogen volume in the hydrogen reservoir.

This refueling method can also be carried out with at least one further hydrogen reservoir, wherein the hydrogen reservoirs can be connected to the hydrogen tank in succession. By replenishing working fluid in the respective hydrogen reservoir, the hydrogen in the respective hydrogen reservoir can be recompressed, in particular brought back to the initial pressure.

Furthermore, the present disclosure also relates to a refueling system, in particular a mobile refueling system, for refueling a hydrogen tank, in particular a vehicle, with hydrogen, comprising:
a hydrogen reservoir containing the hydrogen,
a working fluid reservoir containing a working fluid,
a control device, in particular with a valve controller, for controlling a withdrawal connection for withdrawing hydrogen from the hydrogen reservoir to the hydrogen tank and for controlling an inflow connection between the working fluid storage tank and the hydrogen reservoir, and
a pump with which working fluid can be pumped from the working fluid reservoir to the first hydrogen reservoir.

Further, the present disclosure also relates to a refueling system having a refueling facility as described above and the vehicle, wherein the hydrogen tank of the vehicle is connected to the hydrogen reservoir of the refueling facility.

In the case of the housing-piston assembly according to the invention, the sealing fluid comprises a polyalphaolefin.

For the advantages and effects as well as the preferred compositions of the sealing fluid, reference is made to the explanations above in connection with the working fluid.

In a preferred embodiment, the preferably linearly reciprocating solid piston has a circumferential depression on its end face facing the sealing fluid. In this embodiment, the distance between an end face of the solid piston facing the sealing fluid and a side of the housing facing this end face is therefore greater in the region of the depression than in a region lying radially further inward. As a result, the working volume in the region of the depression can be increased, as a result of which particularly good sealing can be achieved.

As seen in the longitudinal section of the solid piston, the depression may be curved. As a result, a contact area between the sealing fluid and the solid piston can be increased, as a result of which the sealing fluid can be pressed against an inner wall of the solid piston. As a result, the sealing effect can be further improved.

In a preferred embodiment, the housing has an outer housing part and a cylindrical insert or running sleeve inside the outer housing part. The insert sleeve may be made of a ceramic material, for example. Alternatively, the insert sleeve may have a coating of DLC (“diamond-like carbon”, i.e. amorphous carbon layers) on the inside.

In a preferred embodiment, the piston has at least one circumferential sealing groove, preferably a plurality of sealing grooves spaced apart in the axial direction of the piston. The at least one sealing groove causes a pressure reduction, which can prevent the working fluid from being able to leave the working volume along the outside of the piston. In addition, an additional mechanical seal can be accommodated in the sealing groove.

The invention further relates to an axial or radial piston pump having a cylinder-piston assembly in one of the embodiments described above.

In the rotor according to the invention, the rotary drive is configured to rotate the housing-piston assembly about the axis of rotation.

In a preferred embodiment, the axis of rotation is substantially perpendicular to the longitudinal axis of the solid piston.

In an alternative embodiment, the axis of rotation may be extended along the longitudinal axis of the piston.

The method according to the invention for sealing the movement of a solid piston relative to a housing comprises at least the following steps:
(a) providing the housing-piston assembly in any of the above-described embodiments, wherein the solid piston is arranged in a first position relative to the housing, and
(b) moving the solid piston relative to the housing from the first position to a second position, thereby changing the working volume enclosed by the housing, wherein the movement of the solid piston relative to the housing is sealed with the sealing fluid.

In the first position, the end face of the solid piston facing the sealing fluid may be at a greater distance from a side of the housing facing this end face than in the second position. Then, by moving the solid piston to the second position, the working volume is reduced.

The housing-piston assembly is preferably rotated about the axis of rotation. Thereby, as a result of inertia, a centrifugal force can act on the sealing fluid, driving the sealing fluid outward in such a way that a further improved seal can be achieved.

Hydrogen can be provided in the working volume, which can be at least partially compressed and/or at least partially discharged through an opening arranged in the housing by moving the solid piston in step (b). The opening may be arranged on a side of the housing in the direction of which the movement of the piston takes place in order to reduce the working volume.

The invention is described in more detail below with reference to preferred exemplary embodiments which are illustrated in the figures.

For purposes of this disclosure, “hydrogen” always refers to molecular hydrogen (H2).

### BRIEF DESCRIPTION OF THE FIGURES

FIGS. 1 and 2 show a longitudinal section of a hydrogen reservoir in two different states, wherein a polyalphaolefin is used as a liquid piston for displacing and/or compressing hydrogen.

FIGS. 3 and 4 show a longitudinal section of a housing-piston assembly in two different states, wherein a polyalphaolefin is sealed as a circumferential seal for sealing the reciprocating movement of a solid piston along the housing designed as a cylinder.

### DETAILED DESCRIPTION

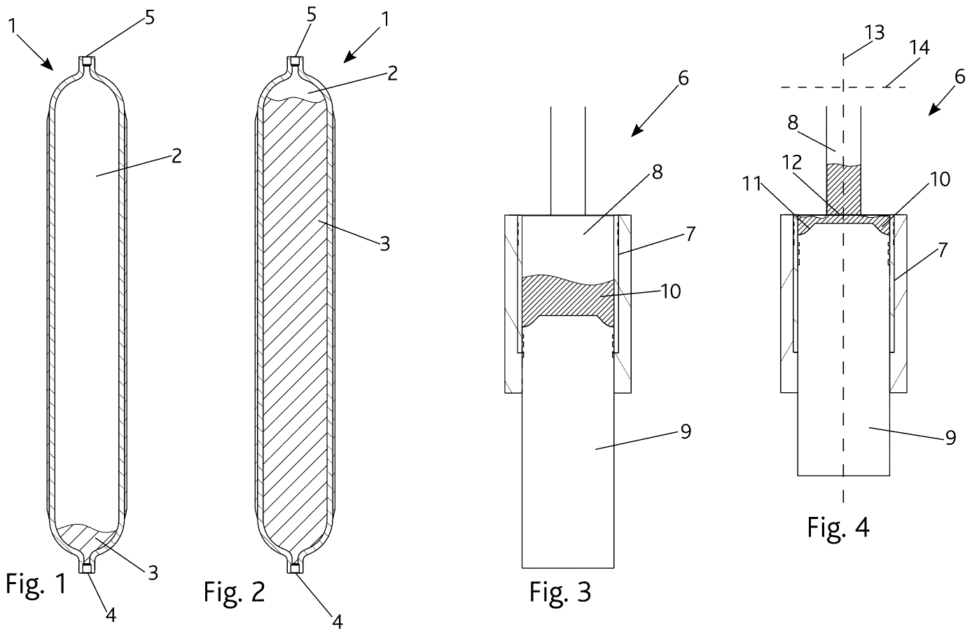

FIG. 1 and FIG. 2 show a hydrogen compressor or hydrogen displacer, which is designed here as a hydrogen reservoir 1 for storing, withdrawing and recompressing the hydrogen remaining in the hydrogen reservoir 1. According to FIG. 1, the hydrogen reservoir is in a first state. The hydrogen reservoir 1 has a hydrogen volume filled with hydrogen 2 and a working fluid volume filled with a working fluid 3, which together result in a filling space of the hydrogen reservoir. The working fluid 3 comprises a mixture of polyalphaolefins having 16 to 18 hydrocarbon atoms per molecule. The working fluid 3 is designed as a liquid piston, which is in direct contact with the hydrogen (i.e. without a solid piston arranged in between), so that the interface with the hydrogen can be displaced with the working fluid 3. The hydrogen reservoir 1 has a first opening 4, via which the working fluid 3 can be replenished by a working fluid reservoir (not shown). In addition, the hydrogen reservoir 1 has a second opening 5, via which the hydrogen 2 can be discharged from the hydrogen reservoir 1. In the embodiment shown, the first opening 4 is formed on a bottom of the hydrogen reservoir 1 and the second opening 5 is formed on an upper side of the hydrogen reservoir 1.

For the purposes of this disclosure, the location and direction indications, such as “top” and “bottom”, refer to the intended state of use of the hydrogen reservoir 1.

In a preferred embodiment, the hydrogen reservoir 1 is a component of a refueling system that can be connected to a hydrogen vehicle in order to fill a hydrogen tank of the hydrogen vehicle with hydrogen (not shown).

According to FIG. 1, the working fluid occupies a first working fluid volume inside the hydrogen reservoir 1. Thus, in the first state, the working fluid has a first filling level.

By replenishing working fluid 3 into the hydrogen reservoir 1, the working fluid volume can be increased and the hydrogen volume correspondingly reduced. In this case, part of the hydrogen 2 can be compressed in the hydrogen volume, while another part can be discharged from the hydrogen reservoir 1 and, in a preferred application, fed to the tank of the hydrogen vehicle.

FIG. 2 shows the hydrogen reservoir 1 of FIG. 1 in a second state, wherein working fluid 3 has been replenished. The working fluid occupies a second working fluid volume which is greater than the first working fluid volume. Thus, in the second state, the working fluid has a second fill level, which is higher than the first fill level.

FIG. 3 and FIG. 4 show a second embodiment according to the invention, in which the polyalphaolefin is used as a sealing fluid.

FIG. 3 shows a housing-piston assembly 6 in a first state. The housing-piston assembly 6 has a housing 7, which, in the embodiment shown, has an outer housing part and a cylindrical insert or running sleeve, which fills a cylindrical recess of the outer housing part. The insert sleeve may be made of a ceramic material, for example. Alternatively, the insert sleeve may have a coating of DLC on the inside. The housing 7 internally encloses a working volume in which hydrogen 8 is accommodated. Furthermore, the housing-piston assembly 6 has a solid piston 9, which is axially displaceable along the inner wall of the housing 7 with a substantially precise fit in order to change the working volume. Unlike in the previous embodiment, according to FIG. 3 and FIG. 4, no liquid piston is provided, but rather the solid piston 9, which is embodied as a machine component that is substantially unchanging in shape. In order to seal the movement of the solid piston 9 relative to the housing 7, a sealing fluid 10 is provided, which prevents the hydrogen 8 from passing from the working volume to the side of the piston 9 facing away from the working volume. In addition, at least one circumferential sealing groove, preferably a plurality of sealing grooves spaced apart in the axial direction of the piston 9, can be provided on the circumference of the piston 9. The at least one sealing groove provides for a pressure reduction, which prevents the working fluid from being able to leave the working space along the piston 9. In addition, an additional mechanical seal can be accommodated in the sealing groove.

In the embodiment shown, the sealing fluid 10 consists of a mixture of polyalphaolefins having 16 to 18 hydrocarbon atoms per molecule. On its end face facing the sealing fluid 10, the solid piston 9 has a circumferential depression 11, which is curved in the longitudinal section of the piston 9. An opening 12 is arranged in one side of the housing 7, in the direction of which the piston 9 is moved in order to reduce the working volume, in order to discharge the hydrogen 8.

In FIG. 3, the piston 9 is arranged in a first position relative to the housing 7. In this first position, the end face of the solid piston 9 facing the sealing fluid 10 is at a comparatively large distance from a side of the housing 7 facing this end face. Accordingly, the working volume is comparatively large. By axially moving the solid piston 9 toward a second position, the working volume enclosed by the housing 7 can be reduced. Part of the hydrogen 8 can thereby be compressed, while another part can be discharged from the housing 7 through the opening 12.

FIG. 4 shows the housing-piston assembly 6 of FIG. 3 in a second state. The solid piston 9 is arranged in a second position, in which the working volume is smaller than in the first state of the housing-piston assembly 6. The sealing fluid 10 fills the sealing locations adjacent to the inside of the housing 7, thereby sealing the movement of the solid piston 9 relative to the housing 7. By rotating the housing-piston assembly 6 about an axis of rotation 14 that is perpendicular to a longitudinal axis of the solid piston 9, a centrifugal force can act on the sealing fluid 10, whereby the sealing fluid 10 can be pressed even better against the inside of the housing 7, so that the sealing is further improved.

1. A hydrogen compressor or displacer for hydrogen, in comprising:
a hydrogen volume filled with hydrogen, and
a working fluid volume filled with a working fluid, wherein the working fluid is designed as a liquid piston for changing the hydrogen volume,
wherein the working fluid comprises a polyalphaolefin, and wherein at least 90% by weight of the polyalphaolefin comprises 19 or fewer carbon atoms per molecule.

2. The hydrogen compressor or displacer according to claim 1, wherein the working fluid comprises the polyalphaolefin in an amount of at least 80% by weight, based on a total weight of the working fluid.

3. The hydrogen compressor or displacer according to claim 1, wherein at least 90% by weight of the polyalphaolefin has 14 to 18 carbon atoms per molecule, based on a total weight of the polyalphaolefin.

4. The hydrogen compressor or displacer according to claim 1, wherein a maximum of 10% by weight of the polyalphaolefin has 20 or more carbon atoms per molecule, based on a total weight of the polyalphaolefin.

5. The hydrogen compressor or displacer according to claim 1, wherein the working fluid has a content of an aromatic hydrocarbon of 1% by weight or less, based on a total weight of the working fluid.

6. The hydrogen compressor or displacer according to claim 1, wherein the working fluid has a viscosity selected from a range of 1 to 5 cSt at 70 °C.

7. A method for displacing and/or compressing hydrogen, comprising the steps of:
(a) providing the hydrogen compressor or displacer according to claim 1, and
(b) replenishing working fluid into the hydrogen compressor or displacer such that the working fluid volume of the hydrogen compressor and/or displacer is increased and the hydrogen volume of the hydrogen compressor or displacer is reduced.

8. A housing-piston assembly comprising:
a housing, wherein the housing includes a working volume for receiving hydrogen,
a solid piston movable relative to the housing for changing the working volume, and
a seal for sealing the movement of the solid piston relative to the housing, wherein a sealing fluid is provided as the seal,
wherein the sealing fluid comprises a polyalphaolefin, and wherein at least 90% by weight of the polyalphaolefin comprises 19 or fewer carbon atoms per molecule.

9. The housing-piston assembly according to claim 8, wherein at least 90% by weight of the polyalphaolefin has 14 to 18 carbon atoms per molecule, based on a total weight of the polyalphaolefin.

10. The housing-piston assembly according to claim 8, wherein the solid piston has a circumferential depression on its end face facing the sealing fluid.

11. The housing-piston assembly according to claim 10, wherein the depression is curved as viewed in the longitudinal section of the solid piston.

12. A rotor comprising:
an axis of rotation,
a rotary drive, and
the housing-piston assembly according to claim 8, wherein the rotary drive is configured to rotate the housing-piston assembly about the axis of rotation.

13. The rotor according to claim 12, wherein the axis of rotation is perpendicular to the longitudinal axis of the solid piston.

14. A method of sealing the movement of a piston relative to a housing, comprising the steps of:
(a) providing the housing-piston assembly according to claim 8, wherein the solid piston is arranged in a first position relative to the housing, and
(b) moving the solid piston relative to the housing from the first position to a second position, thereby changing the working volume enclosed by the housing, wherein the movement of the solid piston relative to the housing is sealed with the sealing fluid.

15. The method according to claim 14, wherein the housing-piston assembly is rotated about an axis of rotation.

16. An axial or radial piston pump with the cylinder-piston assembly according to claim 8.

17. A hydrogen reservoir for storing hydrogen, comprising the hydrogen compressor or displacer according to claim 1.

18. The hydrogen compressor or displacer according to claim 6, wherein the working fluid has a viscosity of 2.5 to 4 cSt at 70 °C.

19. The method according to claim 7, wherein replenishing the working fluid into the hydrogen compressor or displacer comprises replenishing the working fluid into the hydrogen compressor or displacer by means of an axial piston or radial piston pump.

20. The housing-piston assembly according to claim 8, wherein the housing is a cylinder.
